(19) United States
(12) Patent Application Publication
(10) Pub. No.: US 2013/0166282 A1
(43) Pub. Date: Jun. 27, 2013

(54) METHOD AND APPARATUS FOR RATING DOCUMENTS AND AUTHORS

(71) Applicant: Federated Media Publishing, LLC, San Jose, CA (US)

(72) Inventors: Peter Ridge, San Jose, CA (US); Tim Musgrove, Morgan Hill, CA (US)

(73) Assignee: FEDERATED MEDIA PUBLISHING, LLC, San Jose, CA (US)

(21) Appl. No.: 13/725,503

(22) Filed: Dec. 21, 2012

Related U.S. Application Data
(60) Provisional application No. 61/578,861, filed on Dec. 21, 2011.

(51) Int. Cl. G06F 17/27

(52) U.S. Cl. CPC G06F 17/2785
USPC 704/9

(57) ABSTRACT

Methods and apparatus for determining a competence rating of an author relating to one or more topics is disclosed. An exemplary method comprises determining semantic information associated with one or more documents related to the one or more topics, determining amplification information associated with the one or more documents, determining occurrence information associated with the author; and determining a competence rating for the author based at least in part on the semantic information associated with the one or more documents, the amplification information associated with the one or more documents, and the occurrence information associated with the author. A document rating for at least one of the one or more documents may also be determined based at least in part on the one or more weighted semantic features and the amplification information.

### RELATED APPLICATION DATA

This application claims priority to U.S. Provisional Application 61/578,861, filed Dec. 21, 2011, which is hereby incorporated by reference in its entirety.

### FIELD OF THE INVENTION

The disclosed embodiment relates to rating documents and authors based on a variety of factors.

### SUMMARY OF THE INVENTION

The disclosed embodiment relates to a method and apparatus for determining a competence rating of an author relating to topics. An exemplary method comprises determining semantic information associated with documents related to the topics, determining amplification information associated with the documents, determining occurrence information associated with the author, and determining a competence rating for the author based at least in part on the semantic information associated with the documents, the amplification information associated with the documents, and the occurrence information associated with the author. A document rating for the documents may also be determined based at least in part on the weighted semantic features and the amplification information.

As disclosed herein, the semantic information can be associated with any number of topics, and can be associated with, for example, reading level, grammatical correctness, average sentence length and range of vocabulary, topic density, number, density and class of references, presence of argumentation indicators, dialog indicators, first person narrative or authoritative verbiage, the presence of various surface representations of sub-topics or related topics to the topics, and semantics of comments associated with the documents. The semantic information may also be based at least in part on weighted semantic features. In addition, the amplification information may be based at least in part on where the documents are published, and the occurrence information may be based on, for example, the number of documents the author has written related to the topics, how recently the author has written documents related to the topics, and how frequently the author has written documents related to the topics. The documents may include existing documents, new documents, or both.

The apparatus of the disclosed embodiment preferably comprises one or more processors, and one or more memories operatively coupled to at least one of the one or more processor. The memories have instructions stored thereon that, when executed by at least one of the one or more processors, cause at least one of the one or more processors to carry out the disclosed methods.

The disclosed embodiment further relates to non-transitory computer-readable media storing computer-readable instructions that, when executed by one or more computing devices, cause at least one of the one or more computing devices to carry out the disclosed methods.

### BRIEF DESCRIPTION OF THE DRAWINGS

These and other features, aspects, and advantages of the present disclosure will be better understood when the following detailed description is read with reference to the accompanying drawings in which like characters represent like parts throughout the drawings, wherein:

FIG. 1 illustrates an exemplary method according to the disclosed embodiment.

FIG. 2 shows a diagram illustrating exemplary associated with the disclosed semantic information according to the disclosed embodiment.

FIG. 3 shows a diagram illustrating the information associated with the disclosed document rating according to the disclosed embodiment.

FIG. 4 shows a diagram illustrating the information associated with the disclosed occurrence information according to the disclosed embodiment.

FIG. 5 illustrates an exemplary method for building training information according to the disclosed embodiment.

FIG. 6 illustrates an exemplary method for rating documents and authors according to the disclosed embodiment.

FIG. 7 illustrates an exemplary computer system according to the disclosed embodiment.

### DETAILED DESCRIPTION OF THE INVENTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings. While the invention described herein is provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof.

There exists a need to identify quality authors of articles about various topics who may not be among the “elite” for the topical domains in question. Even among elite authors, there is a need to understand which topics are the real strengths of the author. The disclosed embodiment, which may be referred to as the Semantic Topical Author Rating System (STARS), fulfills this need.

The disclosed embodiment identifies authorial competence (or the lack thereof) independent of over- or under-amplification; i.e., not solely based on whether or not the author is popular or often cited in social networks and other media. It also measures authorial flexibility, which can indicate whether the author can write well across several topics, or just in one, whether the author can adapt well to a new sub-topic which breaks out and requires the integration of tangential or cross-disciplinary literacy, and the like. Clearly, all these metrics demand first that, looking at one document at a time, the quality of the document can be gauged with respect to a given topic and category.

According to the disclosed embodiment, a quality or competence score for documents and their authors is a combination of domain-independent and domain-specific metrics, without reference to any presupposed thresholds. Domain-independent metrics include, but are not limited to, content length, number of words per sentence, paragraph length, reading level, grammar and spelling quality, and horizontal social media network amplification. Domain-specific metrics include, but are not limited to, vertical social media network amplification, inter- and intra-domain breadth and depth of topics covered, and vocabulary selection. Thus, both domain-independent metrics and domain-specific metrics include both semantic information and amplification information.

The methods of the disclosed embodiment do not assume, for example, that writing that uses a more advanced reading level or is very long, with more references and quotes, is automatically better than shorter, less complex writing. Instead, an embodiment of the system enables training against sets of whitelisted (good) and blacklisted (bad) examples of content that are representative of the desired domain or topical area of interest in order to construct features with accompanying ranges of scores that are characteristic of the sets of training documents. This enables the systems of the disclosed embodiment to learn which features matter, and in which direction they point as regards quality within the given topic.

It may be determined that, for example, short posts laden with emotive terms in celebrity and entertainment blogs are often considered to be of high quality, whereas those same qualities in financial management blogs are almost never present in the best-quality writing. Similarly, the desired amplification and behavior metrics may vary according to topic, e.g. high amplification on LinkedIn may be found frequently with experts writing on professional-oriented topics, while Facebook amplification may not be so correlated. (In fact, a high degree of Facebook sharing may even count against quality within certain topics.) By isolating these correlations and trends, the disclosed system ultimately constructs a rich set of features with specific directional weights that are indicative of estimated quality within a topic. Moreover, by balancing the different “dimensions” of features, e.g. semantic, structural, behavioral, etc., the system's sense of “quality writing” is governed to ensure that the final scoring is not unduly dominated by a single dimension.

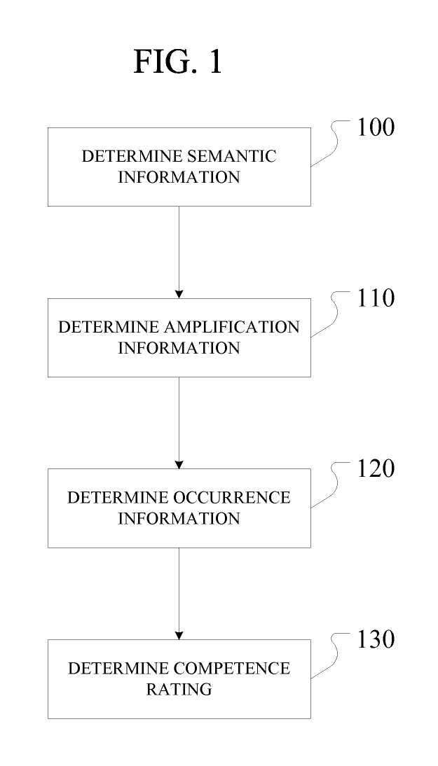

One aspect of the disclosed embodiment shown in FIG. 1 relates to a method and apparatus for determining a competence rating of an author relating to one or more topics. The illustrated method includes steps of determining semantic information 100, determining amplification information 110, determining occurrence information 120, and determining competence rating 130. The semantic information is preferably associated with one or more documents related to one or more topics that are specified by a user, search query, or other source.

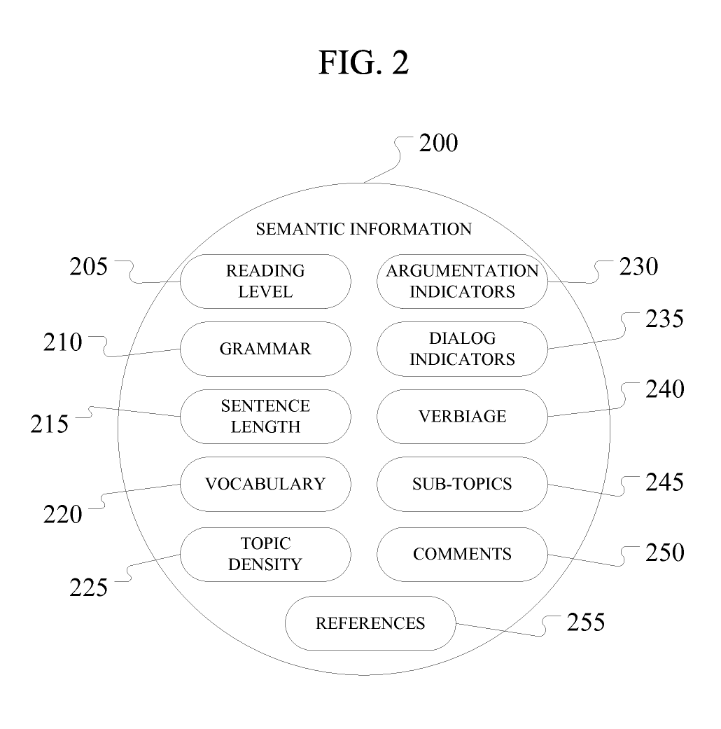

The semantic information preferably includes of various semantic features that are extracted from the documents. These features are utilized because they are likely, in some circumstances, to be positively correlated with higher quality. FIG. 2 illustrates a variety of semantic features that may be used when determining the semantic information 200. Such features may include, but are not limited to, reading level 205 (e.g., 5^{th} grade versus 10^{th} grade level, etc.); grammatical correctness 210; average sentence length 215 and range of vocabulary 220; topic density 225 (such as words per topic); presence of argumentation indicators 230 (suggesting that some explanation or substantiation is being provided); dialog indicators 235; first person narrative or authoritative verbiage 240; the presence of various surface representations of sub-topics or related topics to the main topic in question 245; the semantics of the comments associated with the content 250, and the number, density and class of references 255 (footnotes, hyperlinks, quotations). The semantic factors can be weighted based on their importance.

The disclosed methods also utilize additional data including, but not limited to, the category or categories to which the document belongs, the level of amplification that has been received in various horizontal (topically-broad) and vertical (topically-narrow) social media networks, the number of comments associated with the content, and the like. These types of information are referred to herein as amplification information. More generally, the amplification information may be based at least in part on where the one or more documents are published, and the occurrence information may be based on, for example, the number of documents the author has written related to the one or more topics, how recently the author has written documents related to the one or more topics, and how frequently the author has written documents related to the one or more topics.

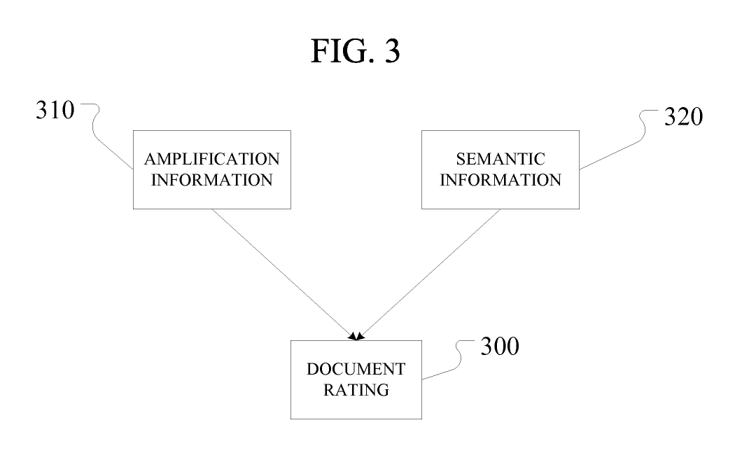

As shown in FIG. 3, after the amplification information 310 and the semantic information 320 are determined, a document rating 300 can be determined for each of the documents being analyzed.

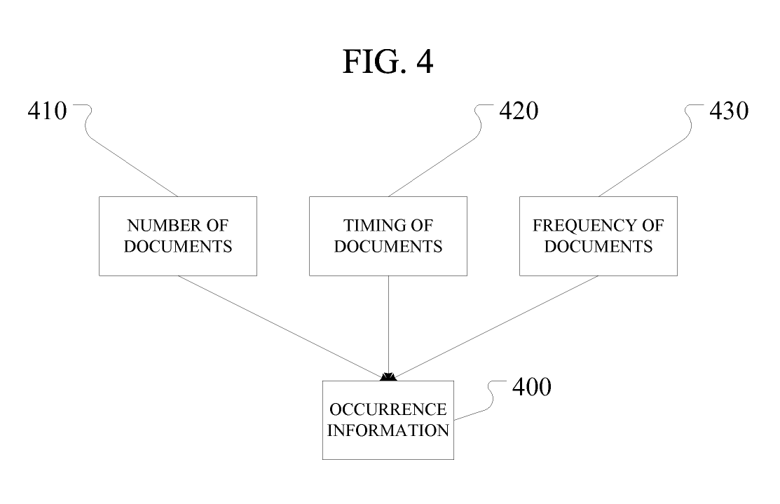

In addition, as shown in FIG. 4, the occurrence information 400, for example, the number of documents 410 the author has written related to the topics, the timing of documents 420 (i.e. how recently the author has written documents related to the topics), the frequency of documents 430 (i.e. how frequently the author has written documents related to the topics), and the like. Of course, occurrence information 400 can be based on additional relevant factors as well, as appropriate.

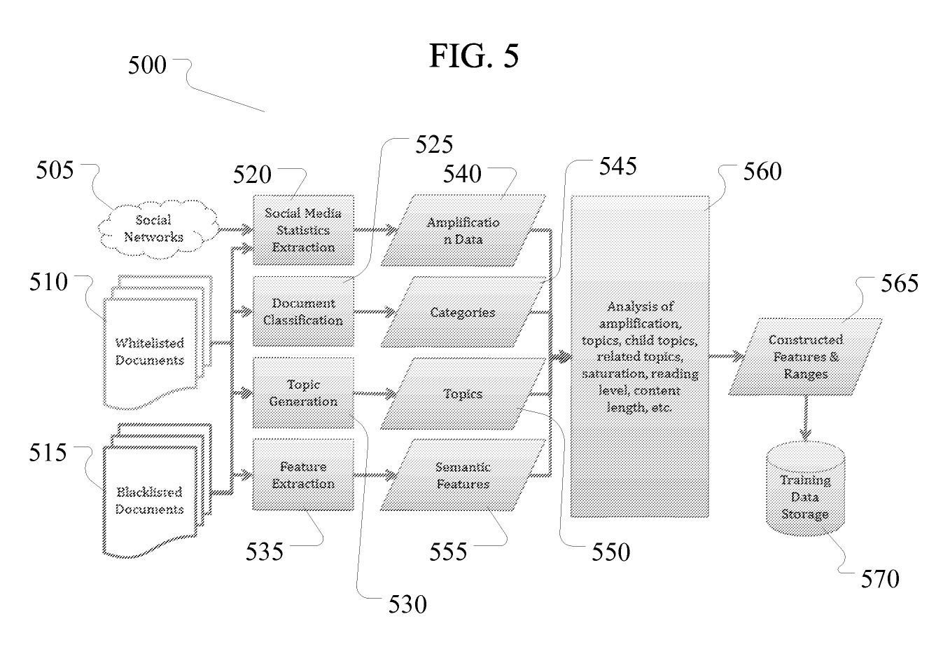

FIG. 5 illustrates a more detailed exemplary workflow 500 for qualifying a subset of various candidate features for use as training data for the system. As shown in FIG. 5, the sources considered include whitelisted documents 510, which are documents that reflect positively on an author, blacklisted documents 515, which are documents that reflect negatively on an author, and social networks 505 (including other web-based resources). These sources can be analyzed, and a wide range of information can be extracted through process blocks including, for example, social media statistics process block 520, document classifications process block 525, topic generations process block 530, and process blocks 535 for various other features. The resulting data blocks include, for example, amplification data block 540 (based on social media statistics process block 520), categories data block 545 (based on document classifications process block 525), topics data block 550 (based on topic generations process block 530), and semantic features data block 555 (based on features process block 535). These data blocks can then be analyzed in process block 560 to yield constructed features and ranges data block 565, which can be stored, for example, in training data storage 570.

As shown in FIG. 5, the disclosed methods seek a non-overlap in the range of n standard-deviations-from-mean between the whitelist documents and the blacklist documents. When there is a non-overlap in these ranges, that feature is selected for inclusion in the scoring metric. Then, each incoming article is scored according to its being within a specified value range for one or several features. After calculating this for all features for an article, the scores are combined using a weighted pie-slice approach, where the size of each slice depends on that feature's independent Pearson correlation with articles appearing on the whitelist or blacklist. In alternative embodiments, a machine learning method that is extant in the literature may be utilized, such as Bayes networks, genetic algorithms, and the like.

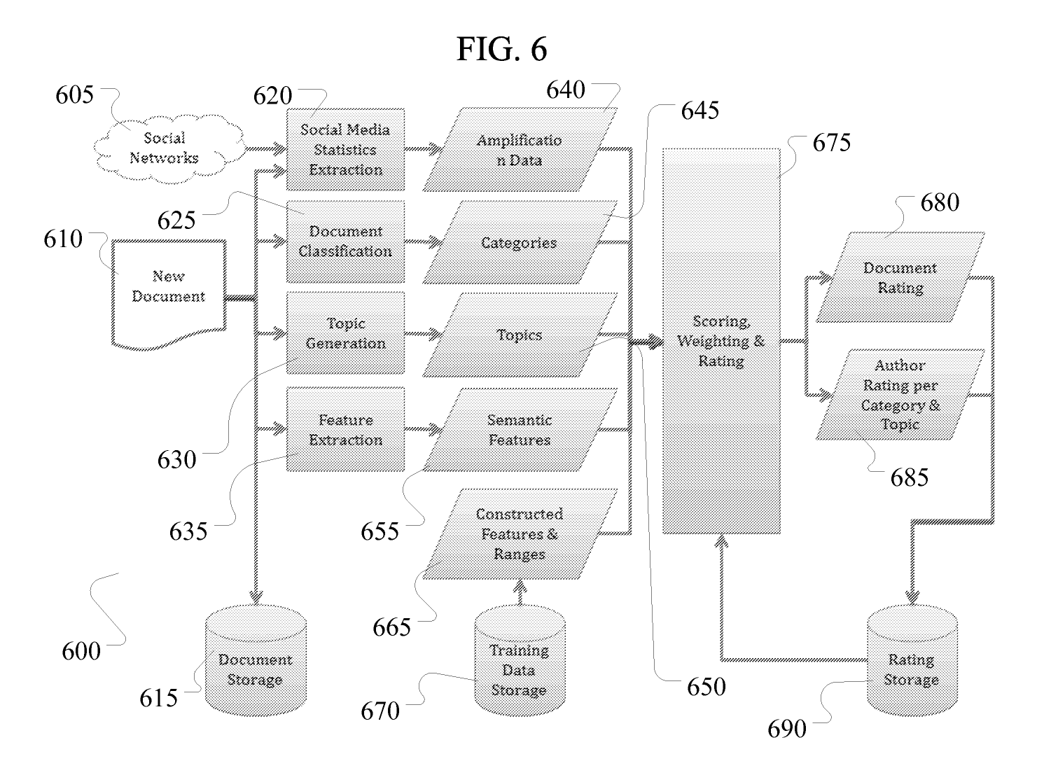

FIG. 6 illustrates the overall process of rating an individual document based on the constructed training data and weighted scoring. As shown in FIG. 6, the sources considered include social networks 605 and a new document 610, which may be stored, for example, in document storage 615. These sources can be analyzed, and a wide range of information can be extracted through process blocks including, for example, social media statistics process block 620, document classifications process block 625, topic generations process block 630, and process blocks 635 for various other features. The resulting data blocks include, for example, amplification data block 640 (based on social media statistics process block 620), categories data block 645 (based on document classifications process block 625), topics data block 650 (based on topic generations process block 630), and semantic features data block 655 (based on features process block 635). These data blocks can be combined with data from training data storage 670 via constructed features and ranges process block 665, and analyzed in scoring, weighting, and rating information process block 675 to yield document ratings data block 680 and author ratings data block 685. The ratings data can be stored, for example, in rating storage 690, and can be re-used during the analysis in scoring, weighting, and rating information process block 675, if desired.

Once individual documents are scored, the scores of all relevant documents by the same author may be evaluated, factoring not only the average or media quality score thereof, but all the extent of the documents (how much literature this author has produced) as well as how recently and how frequently, in order to arrive at a final competence rating for that author with respect to the original topic or topics.

In the above exemplary methods according to the disclosed embodiment, it was assumed that a “given topic” was known in which there was an interest in assessing competence of various authors. Alternatively, the method of the disclosed embodiment may be applied to determine which topic(s) is this author's quality rating (quality of writing) the highest. In such a case, the author's collected writings can be processed through a topic engine (any apparatus that can tag or otherwise filter documents according to topic) to find those that achieve a critical mass of output (defined as having written about topic X at least n number of times, including at least m times in the last t duration of time). Then, each identified topic can be analyzed through the above-disclosed methods and, upon sorting the results, arrive at an author's quality, or competence, profile: the list of topics, in ranked order, in which his or her quality of writing appears to be the highest.

This approach provides an effective methodology that discovers the “diamond in the rough”—the quality author who may not be famous, but perhaps deserves to be—based on how his or her writing compares to that of the elite authors in the category.

### Exemplary Computing Environment

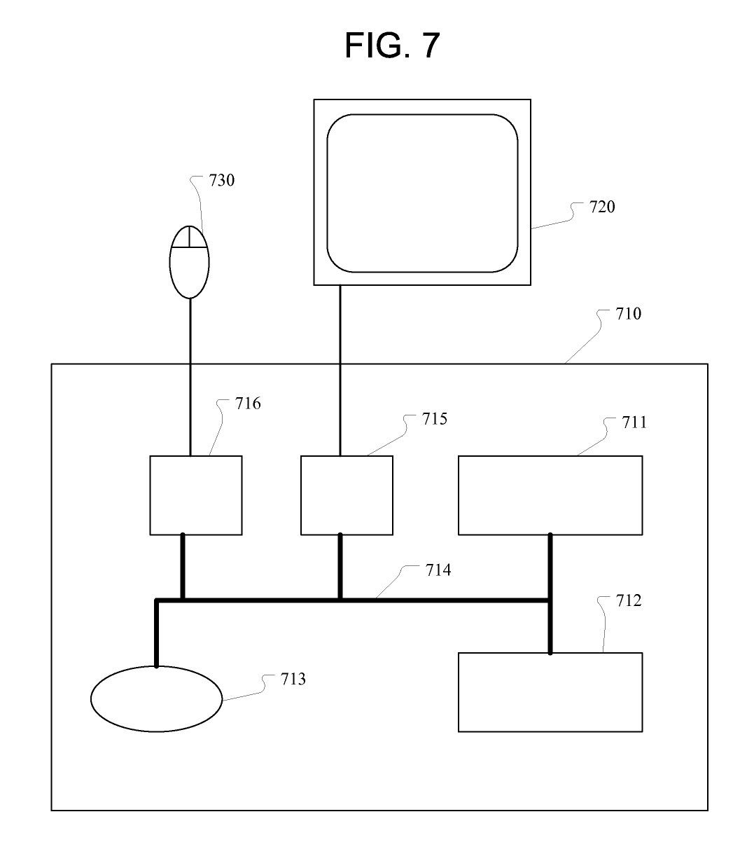

One or more of the above-described techniques may be implemented in or involve one or more computer systems. FIG. 7 illustrates a generalized example of a computing environment 700. The computing environment 700 is not intended to suggest any limitation as to scope of use or functionality of described embodiments.

With reference to FIG. 7, the computing environment 700 includes at least one processing unit 710 and memory 720. In FIG. 7, this most basic configuration 730 is included within a dashed line. The processing unit 710 executes computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. In some embodiments, the memory 720 stores software 780 implementing described techniques.

A computing environment may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other medium which may be used to store information and which may be accessed within the computing environment 700. In some embodiments, the storage 740 stores instructions for the software 780.

The input device(s) 750 may be a touch input device such as a keyboard, mouse, pen, trackball, touch screen, or game controller, a voice input device, a scanning device, a digital camera, or another device that provides input to the computing environment 700. The output device(s) 760 may be a display, printer, speaker, or another device that provides output from the computing environment 700.

The communication connection(s) 770 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 700, computer-readable media include memory 720, storage 740, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A computer-implemented method executed by one or more computing devices for determining a competence rating of an author relating to one or more topics, the method comprising:
determining, by at least one of the one or more computing devices, semantic information associated with one or more documents related to the one or more topics;
determining, by at least one of the one or more computing devices, amplification information associated with the one or more documents;
determining, by at least one of the one or more computing devices, occurrence information associated with the author; and
determining, by at least one of the one or more computing devices, a competence rating for the author based at least in part on the semantic information associated with the one or more documents, the amplification information associated with the one or more documents, and the occurrence information associated with the author.

2. The method of claim 1, wherein the semantic information relates to at least one of reading level, grammatical correctness, average sentence length and range of vocabulary, topic density, number, density and class of references, presence of argumentation indicators, dialog indicators, first person narrative or authoritative verbiage, the presence of various surface representations of sub-topics or related topics to the one or more topics, and semantics of comments associated with the one or more documents.

3. The method of claim 1, wherein the semantic information is based at least in part on one or more weighted semantic features.

4. The method of claim 3, further comprising determining a document rating for at least one of the one or more documents based at least in part on the one or more weighted semantic features and the amplification information.

5. The method of claim 1, wherein the amplification information is based at least in part on where the one or more documents are published.

6. The method of claim 1, wherein the occurrence information is based on at least one of the number of documents the author has written related to the one or more topics, how recently the author has written documents related to the one or more topics, and how frequently the author has written documents related to the one or more topics.

7. The method of claim 1, wherein the one or more documents include at least one of an existing document and a new document.

8. An apparatus for determining a competence rating of an author relating to one or more topics, the apparatus comprising:
one or more processors; and
one or more memories operatively coupled to at least one of the one or more processors and having instructions stored thereon that, when executed by at least one of the one or more processors, cause at least one of the one or more processors to:
determine semantic information associated with one or more documents related to the one or more topics;
determine amplification information associated with the one or more documents;
determine occurrence information associated with the author; and
determine a competence rating for the author based at least in part on the semantic information associated with the one or more documents, the amplification information associated with the one or more documents, and the occurrence information associated with the author.

9. The apparatus of claim 8, wherein the semantic information relates to at least one of reading level, grammatical correctness, average sentence length and range of vocabulary, topic density, number, density and class of references, presence of argumentation indicators, dialog indicators, first person narrative or authoritative verbiage, the presence of various surface representations of sub-topics or related topics to the one or more topics, and semantics of comments associated with the one or more documents.

10. The apparatus of claim 8, wherein the semantic information is based at least in part on one or more weighted semantic features.

11. The apparatus of claim 10, wherein at least one of the one or more memories has further instructions stored thereon that, when executed by at least one of the one or more processors, cause at least one of the one or more processors to determine a document rating for at least one of the one or more documents based at least in part on the one or more weighted semantic features and the amplification information.

12. The apparatus of claim 8, wherein the amplification information is based at least in part on where the one or more documents are published.

13. The apparatus of claim 8, wherein the occurrence information is based on at least one of the number of documents the author has written related to the one or more topics, how recently the author has written documents related to the one or more topics, and how frequently the author has written documents related to the one or more topics.

14. The apparatus of claim 8, wherein the one or more documents include at least one of an existing document and a new document.

15. At least one non-transitory computer-readable medium storing computer-readable instructions that, when executed by one or more computing devices, cause at least one of the one or more computing devices to:
determine semantic information associated with one or more documents related to the one or more topics;
determine amplification information associated with the one or more documents;
determine occurrence information associated with the author; and
determine a competence rating for the author based at least in part on the semantic information associated with the one or more documents, the amplification information associated with the one or more documents, and the occurrence information associated with the author.

16. The at least one non-transitory computer-readable medium of claim 15, wherein the semantic information relates to at least one of reading level, grammatical correctness, average sentence length and range of vocabulary, topic density, number, density and class of references, presence of argumentation indicators, dialog indicators, first person narrative or authoritative verbiage, the presence of various surface representations of sub-topics or related topics to the one or more topics, and semantics of comments associated with the one or more documents.

17. The at least one non-transitory computer-readable medium of claim 15, wherein the semantic information is based at least in part on one or more weighted semantic features.

18. The at least one non-transitory computer-readable medium of claim 17, further comprising instructions that, when executed by one or more computing devices, cause at least one of the one or more computing devices to determine a document rating for at least one of the one or more documents based at least in part on the one or more weighted semantic features and the amplification information.

19. The at least one non-transitory computer-readable medium of claim 15, wherein the amplification information is based at least in part on where the one or more documents are published.

20. The at least one non-transitory computer-readable medium of claim 15, wherein the occurrence information is based on at least one of the number of documents the author has written related to the one or more topics, how recently the author has written documents related to the one or more topics, and how frequently the author has written documents related to the one or more topics.

21. The at least one non-transitory computer-readable medium of claim 15, wherein the one or more documents include at least one of an existing document and a new document.
